(19) United States
(12) Patent Application Publication
(10) Pub. No.: US 2006/0126879 A1
(43) Pub. Date: Jun. 15, 2006

(54) SPEAKER MODULE

(76) Inventor: Hsien-Hung Kuo, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/908,873

(22) Filed: May 31, 2005

(30) Foreign Application Priority Data
Dec. 10, 2004 (TW) 93219933

(51) Int. Cl. H04R 1/02; H04R 1/20; A47B 81/06

(52) U.S. Cl. 381/354; 381/345; 181/198

(57) ABSTRACT

A speaker module comprising a housing, a speaker enclosure, a speaker unit and a buffer element is provided. The housing has an orientating element connected to an inner wall of the housing to form a mounting space inside the housing. The speaker enclosure is disposed inside the mounting space. The speaker unit is mounted on the speaker enclosure. The buffer element is disposed between the speaker enclosure and the orientating element. When the speaker operates, the vibration from the speaker unit and the speaker enclosure are buffered by the buffer element. Meanwhile, the sound produced by the speaker unit can be free from other sounds from various directions so that the quality of sound produced by the speaker module can be maintained.

### CROSS-REFERENCE TO RELATED APPLICATION

This application claims the priority benefit of Taiwan application serial no. 93219933, filed on Dec. 10, 2004. All disclosure of the Taiwan application is incorporated herein by reference.

### BACKGROUND OF THE INVENTION

1. Field of the Invention

The present invention relates to a speaker module. More particularly, the present invention relates to a speaker module having a buffer element for buffering the vibration generated by a speaker unit inside the speaker module.

2. Description of the Related Art

With the advancement in electronic technologies in recent years, the variety of multimedia devices such as notebook computers, personal computers, mobile phones and personal digital assistants (PDA) has increased exponentially. Because human beings receive external messages mainly through visual and audio senses, all of these multimedia devices are equipped with at least a monitor and a speaker for providing a user with video and audio information. Although most of the aforementioned electronic devices already have a built-in speaker, users usually hook up additional speakers to the electronic device for better sound quality.

FIG. 1 is a schematic cross-sectional view of a conventional speaker module. As shown in FIG. 1, a conventional speaker module 100 mainly comprises a speaker unit 110 and a housing 120. In general, the speaker unit 110 is a conventional disk-shaped speaker unit and the housing 120 serves as a speaker enclosure for the speaker unit 110. It should be noted that the speaker unit 110 and the housing 120 are assembled together with screws 130 fastening the speaker unit 110 to the housing 120.

Since the speaker unit 110 is solidly fastened to the housing 120 by screws 130, the vibration produced by the speaker unit 110 will be transmitted to the housing 120 via the screws 130. Therefore, the resonance frequency of the speaker module 100 will easily fall within the operating frequency range of the speaker unit 110 and lead to resonance effect of the whole speaker module 100. Ultimately, the sound quality produced by the speaker unit 110 will likely deteriorate.

### SUMMARY OF THE INVENTION

Accordingly, at least one objective of the present invention is to provide a speaker module capable of maintaining a high sound quality output from a speaker unit thereof.

To achieve these and other advantages and in accordance with the purpose of the invention, as embodied and broadly described herein, the invention provides a speaker module. The speaker module comprises a housing, a speaker enclosure, a speaker unit and a buffer element. The housing has an orientating element therein and the orientating element forms a mounting space. The speaker enclosure is disposed inside the mounting space. The speaker unit is mounted on the speaker enclosure. The buffer element is disposed between the speaker enclosure and the orientating element for buffering the vibration from the speaker unit and the speaker enclosure.

According to one embodiment of the present invention, the housing of the speaker module has an opening for example, such that the speaker unit faces the opening.

According to one embodiment of the present invention, the housing of the speaker module comprises a top cover and a corresponding bottom cover. The orientating element is connected to an inner wall of the bottom cover. In addition, the top cover further includes an orienting protrusion so that the buffer element can be fixed inside the mounting space through the orienting protrusion and the orientating element.

According to one embodiment of the present invention, the buffer element of the speaker module is a spongy layer.

Accordingly, in the speaker module of the present invention, a buffer element is disposed in the space between an orientating element and a speaker enclosure, while a speaker unit is mounted on the speaker enclosure. When the speaker unit operates, the vibration transmitted from the speaker unit and the speaker enclosure to the housing is reduced to the minimum through the buffering of the buffer element. Furthermore, through the buffering of the buffer element, the sound produced by the speaker unit can be free from interference by other sounds from various directions. Hence, the speaker module can produce high quality sound.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view of a conventional speaker module.

FIG. 2 is a schematic cross-sectional view of a speaker module according to one embodiment of the present invention.

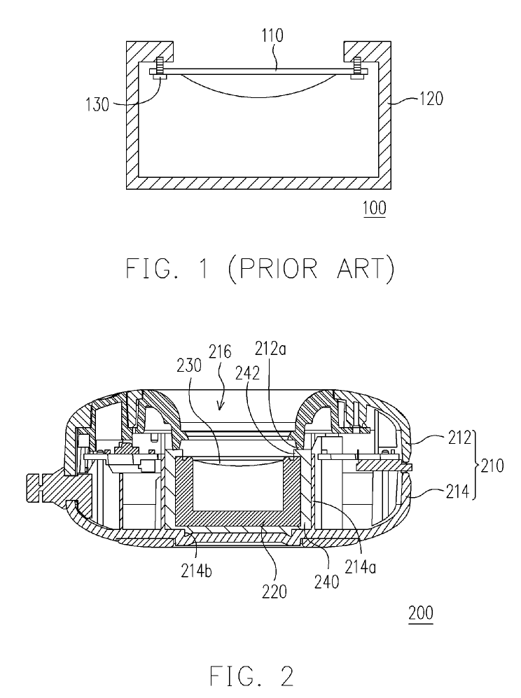

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

FIG. 2 is a schematic cross-sectional view of a speaker module according to one embodiment of the present invention. As shown in FIG. 2, the speaker module 200 of the present embodiment is used to be connected to an electronic device for providing a user with audio information such as voice messages or music. The electronic device can be a notebook computer, a desktop computer or a mobile phone.

The speaker module 200 in the present embodiment mainly comprises a housing 210, a speaker enclosure 220, a speaker unit 230 and a buffer element 240. The housing 210 has an orientating element 214a. The orientating element 214a is a circular recess slot or a rectangular recess slot connected to the inner walls of the housing 210, for example. In the present embodiment, the orientating element 214a is connected to the inner walls of the housing 210 to form a mounting space. It should be noted that the method of connecting the orientating element 214a to the inner walls of housing 210 includes injection molding so that the orientating element 214a and the housing 210 are formed as a whole. In addition, in another embodiment of the present invention, the orientating element 214a can be connected to the inner walls of the housing 210 by screws, latches or adhesives.

To transmit the sound produced by the speaker unit 230 directly to locations outside the housing 210, the housing 210 has an opening 216 located on a top cover 212 of the housing 210 such that the speaker unit 230 faces the opening 216.

Since the housing 210 is used to contain and protect the speaker enclosure 220 and the speaker unit 230, it can be designed as a single unit or multiple units. In the drawing of the present invention, the housing 210 is fabricated using a plurality of units. In the present embodiment, the housing 210 comprises a top cover 212 and a corresponding bottom cover 214. The orientating element 214a is connected to an inner wall of the bottom cover 214.

The speaker unit 230 is mounted on the speaker enclosure 220. The method of mounting the speaker unit 230 includes, for example, forming latching elements that can engage with each other on the speaker unit 230 and the speaker enclosure 220 respectively so that the speaker unit 230 can be fastened inside the speaker enclosure 220. In another embodiment of the present invention, the speaker unit 230 can be solidly fastened to the speaker enclosure 220 by screws. Obviously, the aforementioned mounting method is only an example. Hence, it should by no means limit the scope of the present invention. In addition, the speaker unit 230 is a conventional disk-shaped speaker unit, for example.

The buffer element 240 is disposed in the space between the speaker enclosure 220 and the orientating element 214a for buffering the vibration from the speaker unit 230 and the speaker enclosure 220. To provide better buffering effect, the buffer element 240 can be a spongy layer or other suitable buffering material layer. Furthermore, the buffer element 240 can be a single layer structure or a multi-layered structure.

To fix the speaker enclosure 220 and the mounted speaker unit 230 firmly within the mounting space of the orientating element 214a, the top cover 212 of the housing 210 has an orienting protrusion 212a for applying a pressure on a protruding section 242 of the buffer element 240. The protruding section 242 encloses a portion of the top surface of the speaker enclosure 220 so that the speaker enclosure 220 enclosed by the buffer element 240 can position firmly inside the mounting space formed by the orientating element 214a.

Similarly, for the speaker enclosure 220 to be firmly fastened to the mounting space within the orientating element 213a through the buffer element 240, the bottom cover 214 can have a recess portion 214b. The recess portion 214b can be located on the inner wall of the bottom cover 214 within the mounting space formed by the orientating element 214a. Hence, when a portion of the buffer element 240 fills up the recess portion 214b of the bottom cover 214, the recess portion 214b will be lodged into a portion of the buffer element 240, such that the bottom portion of the buffer element 240 can be solidly fastened to the inner wall of the bottom cover 214.

Based on the above description, when the speaker unit 230 operates, the vibration produced by the speaker unit 230 and the speaker enclosure 220 will be transferred to the buffer element 240. Because the buffer element 240 is capable of buffering the vibration from the speaker unit 230 and the speaker enclosure 220, the vibration produced by the speaker unit 230 and the speaker enclosure 220 will almost not be transferred to the housing 210 via the buffer element 240. In the meantime, the sound produced by the speaker unit 230 can be free from other sounds from various directions (for example, the noise created by a resonance between the speaker unit 230 and the housing 210). Therefore, the speaker module 200 can produce high quality sound.

In summary, the speaker module of the present invention utilizes a buffer element to minimize the vibration transmitted from the speaker unit and the speaker enclosure to the housing. Furthermore, through the buffering of the buffer element, the sound produced by the speaker unit can be free from other sounds from various directions (for example, the noise produced by a resonance between the speaker unit and the housing). Hence, the speaker module can produce high quality sound.

In addition, by orienting the speaker enclosure and the mounted speaker unit to the housing through a buffer element, the speaker module of the present invention only has to fit the speaker enclosure mounted with the buffer element and the speaker unit inside the orienting element of the bottom cover of the housing. Thereafter, the top cover of the housing is mounted onto the bottom cover and the orienting protrusion is utilized to press and hold the buffer element in place. Thus, the buffer element of the present invention can simplify the process of assembling a speaker module.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A speaker module, comprising:
a housing having an orientating element therein and the orientating element forms a mounting space;
a speaker enclosure disposed within the mounting space of the orientating element;
a speaker unit mounted on the speaker enclosure; and
a buffer element disposed in the space between the speaker enclosure and the orientating element for buffering the vibrations from the speaker unit and the speaker enclosure.

2. The speaker module of claim 1, wherein the housing has an opening and the speaker unit faces the opening.

3. The speaker module of claim 1, wherein the housing further comprises a top cover and a corresponding bottom cover such that the orientating element is connected to an inner wall of the bottom cover.

4. The speaker module of claim 3, wherein the top cover further comprises an orienting protrusion such that the buffer element is fastened within the mounting space through the orienting protrusion and the orientating element.

5. The speaker module of claim 1, wherein the buffer element comprises a spongy layer.
